(19) United States
(12) Patent Application Publication
(10) Pub. No.: US 2005/0240325 A1
(43) Pub. Date: Oct. 27, 2005

(54) Method and device for operating a motor vehicle including auxiliary systems

(76) Inventors: Rainer Mayer, Weil Der Stadt (DE); Juergen Meier, Ludwigsburg (DE)

Correspondence Address: KENYON & KENYON, ONE BROADWAY, NEW YORK, NY, 10004, US

(21) Appl. No.: 11/113,253

(22) Filed: Apr. 22, 2005

(30) Foreign Application Priority Data
Apr. 23, 2004 (DE) 102004019774.1

(51) Int. Cl. G06F 17/00

(52) U.S. Cl. 701/36; 701/1

(57) ABSTRACT

A method and a device for operating a motor vehicle including auxiliary systems which enable a coordinated and less costly switch-off or performance reduction strategy for the auxiliary systems. At least one switch-off condition is predefined for multiple auxiliary systems as a function of an operating state of the motor vehicle. The presence of the at least one switch-off condition for the auxiliary systems is checked centrally.

### BACKGROUND INFORMATION

It is known that an engine management of a motor vehicle includes an auxiliary system controller. Auxiliary systems are, for example, components, such as an air-conditioner compressor, generator, fan, power-steering pump, heater, etc. For each auxiliary system the auxiliary system controller includes one or multiple switch-off conditions in whose presence the operation of the respective auxiliary system is prohibited or the respective auxiliary system is restricted in its performance. The operating conditions of the motor vehicle and of the respective auxiliary system are separately recorded for each auxiliary system. The switch-off conditions for each auxiliary system are thus specifically recorded and applied in the corresponding auxiliary system module.

### SUMMARY OF THE INVENTION

The method and the device according to the present invention for operating a motor vehicle including auxiliary systems have the advantage that, in the event of the specification of at least one switch-off condition for multiple auxiliary systems, the presence of the at least one switch-off condition for the auxiliary systems is centrally checked as a function of an operating state of the motor vehicle. In this way, one switch-off condition which applies to multiple auxiliary systems needs to be centrally defined and stored only once. Therefore, the switch-off condition does not have to be defined and stored separately for each auxiliary system, thereby saving memory space and computer expenditure. Therefore, the presence of the switch-off condition is checked for centrally so that a comparatively complex check for each affected auxiliary system may be dispensed with. The central check of the switch-off conditions for multiple auxiliary systems results in increased clarity so that interactions and dependencies of the auxiliary systems may be taken into account.

It is particularly advantageous to check the presence of the at least one switch-off condition in a control center outside the auxiliary systems. Due to the control center, a higher-level unit is available which enables a coordination of the switch off of different auxiliary systems in the presence of one switch-off condition in a particularly simple manner.

A further advantage arises when the presence of the at least one switch-off condition is checked in precisely one of the auxiliary systems or in an auxiliary system module assigned to that auxiliary system. In this way, an auxiliary system may be selected for the central check for the presence of the switch-off condition so that a separate control center may be saved.

Furthermore, it is advantageous if, in the presence of the at least one switch-off condition, a switch-off signal or a performance reduction signal is centrally transmitted to the auxiliary systems to be switched off or to be reduced in their performance. In this way, the switch off or the performance reduction of the auxiliary systems in the presence of the switch-off condition may be implemented in a particularly simple and inexpensive manner.

Interactions and dependencies of the auxiliary systems may be taken into account in a simple manner due to the fact that, in the presence of the at least one switch-off condition, the auxiliary systems to be switched off or to be reduced in their performance are switched off or reduced in their performance in a coordinated manner.

A further advantage arises when the auxiliary systems are switched off or reduced in their performance in a predefined sequence. This makes it possible to implement a central coordination in a simple and effective manner.

A further advantage arises when a switch-off condition which is specific for this auxiliary system or the assigned auxiliary system module is checked in at least one of the auxiliary systems or in the auxiliary system module assigned to that auxiliary system. In this way it is possible to also take into account auxiliary system-specific switch-off conditions which do not apply to all auxiliary systems.

### BRIEF DESCRIPTION OF THE DRAWINGS

FIG. 1 shows a block diagram of a device according to the present invention for operating a motor vehicle including auxiliary systems.

FIG. 2 shows a sequence diagram for clarifying the method according to the present invention for operating a motor vehicle including auxiliary systems.

### DETAILED DESCRIPTION

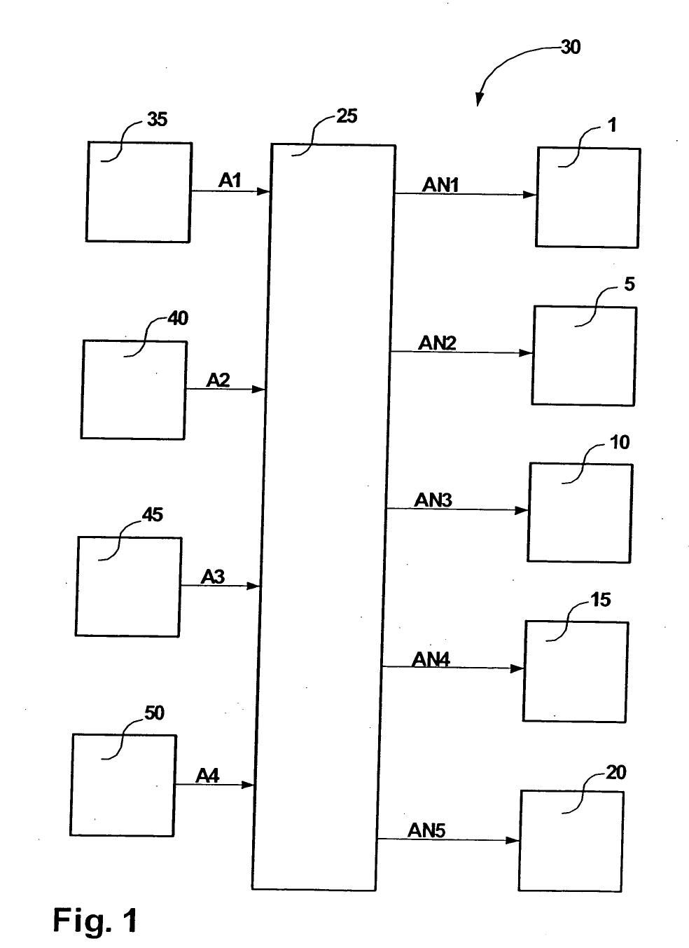

In FIG. 1, reference numeral 30 indicates a device for operating a motor vehicle including auxiliary systems. Device 30 includes first means 35 for detecting a first operating state of the motor vehicle, second means 40 for detecting a second operating state of the motor vehicle, third means 45 for detecting a third operating state of the motor vehicle, and fourth means 50 for detecting a fourth operating state of the motor vehicle. Means 35, 40, 45, 50 may be implemented in an engine management of the motor vehicle in the form of software and/or hardware and may be designed in a manner known to those skilled in the art. First means 35 may be means for detecting a full-load operating state of the motor vehicle, for example. This operating state is determined when, for example, the accelerator pedal is fully depressed so that in the case of a gasoline engine the throttle valve in the air supply is completely opened. It is expedient in the full-load operating state to switch off or at least to reduce the performance of one or multiple activated auxiliary systems so that the maximum possible torque for propulsion is available to the motor vehicle's engine. Second means 40 may be means for detecting an acceleration operating state of the motor vehicle, for example. This operating state is determined, for example, due to the fact that a positive accelerator pedal gradient exists, i.e., the accelerator pedal is increasingly depressed. For determining the vehicle's acceleration operating state, the gradient of the vehicle speed may alternatively also be determined. Increasing driving speed represents an acceleration of the vehicle and thus the acceleration operating state. It is also expedient in the acceleration operating state to switch off or at least to reduce the performance of one or multiple activated auxiliary systems so that the necessary torque for acceleration is available to the motor vehicle's engine. Third means 45 may be means for detecting a starting state of the motor vehicle, for example. This operating state is determined, for example, due to the fact that a starter of the motor vehicle is activated or on the basis of the analysis of the engine speed which, in the motor vehicle's starting state, increases from zero to idle speed. It is also expedient in the motor vehicle's starting state to switch off or at least to reduce the performance of one or multiple activated auxiliary systems so that the necessary torque for starting is available to the motor vehicle's engine. Fourth means 50 may be means, for example, for detecting an operating state of the motor vehicle in which a vehicle system voltage of the motor vehicle is below a predefined threshold value. This operating state is determined, for example, due to the fact that the vehicle system voltage is compared to the predefined threshold value and that the comparison yields that the vehicle system voltage is below the predefined threshold value. It is also expedient in such an operating state to switch off or at least to reduce the performance of one or multiple activated auxiliary systems so that the vehicle system voltage is able to re-exceed the predefined threshold value.

First means 35 check whether the full-load operating state of the motor vehicle is present. If this is the case, they generate a first switch-off signal A1 and convey it to central check means 25 which are also referred to below as the control center. Second means 40 check whether the acceleration operating state of the motor vehicle is present. If this is the case, they generate a second switch-off signal A2 and convey it to control center 25. Third means 45 check whether the starting state of the motor vehicle is present. If this is the case, they generate a third switch-off signal A3 and convey it to control center 25. Fourth means 50 check whether the vehicle system voltage is below the predefined threshold value. If this is the case, they generate a fourth switch-off signal A4 and convey it to control center 25. Control center 25 coordinates switch-off signals Al, A2, A3, A4 received from means 35, 40, 45, 50. These switch-off signals A1, A2, A3, A4 are signals which indicate the fulfillment of a switch-off condition which is dependent on an operating state of the motor vehicle and which is relevant for multiple auxiliary systems of the motor vehicle. These are not signals which indicate the fulfillment of a switch-off condition which depends on a particular auxiliary system itself, i.e., being specific for only the particular auxiliary system and not for other auxiliary systems. Such signals are generated by the individual auxiliary systems themselves or by corresponding auxiliary system modules which are assigned to the individual auxiliary systems and detect the operating state of the individual auxiliary systems.

Control center 25 may also be implemented in an engine management of the motor vehicle in the form of software and/or hardware. Control center 25 coordinates the switch off or performance reduction of multiple auxiliary systems of the motor vehicle when at least one switch-off signal A1, A2, A3, A4 is present. This coordination may mean, for example, that the individual auxiliary systems are switched off or reduced in their performance in a different chronological sequence as a function of triggering switch-off signal(s) A1, A2, A3, A4. Coordination essentially means in this example to form a sequence for the switch off or performance reduction of the auxiliary systems and to indicate for each auxiliary system how significantly its performance should be reduced and, in the extreme case, whether the auxiliary system should be switched off. For this purpose, control center 25 generates suitable switch-off signals or performance reduction signals AN1, AN2, AN3, AN4, AN5 for individual auxiliary systems 1, 5, 10, 15, 20 according to FIG. 1. The transmission sequence of signals AN1, AN2, AN3, AN4, AN5 effectuates a sequence for the switch off and performance reduction of auxiliary systems 1, 5, 10, 15, 20. Individual signals AN1, AN2, AN3, AN4, AN5 additionally indicate the intensity of the performance reduction for individual auxiliary systems 1, 5, 10, 15, 20. A first switch off or performance reduction signal AN1 is transmitted from control center 25 to a first auxiliary system 1. A second switch off or performance reduction signal AN2 is transmitted from control center 25 to a second auxiliary system 5. A third switch off or performance reduction signal AN3 is transmitted from control center 25 to a third auxiliary system 10. A fourth switch off or performance reduction signal AN4 is transmitted from control center 25 to a fourth auxiliary system 15. A fifth switch off or performance reduction signal AN5 is transmitted from control center 25 to a fifth auxiliary system 20. First auxiliary system 1 may be designed as a generator, for example. Second auxiliary system 5 may be designed as a heater, for example. Third auxiliary system 10 may be designed as an air-conditioner compressor, for example. Fourth auxiliary system 15 may be designed as a fan, for example. Fifth auxiliary system 20 may be designed as a power-steering pump, for example.

Based on means 35, 40, 45, 50, it is thus checked at a central point of device 30 whether one or multiple switch-off conditions exist which, dependent on an operating state of the motor vehicle, are relevant for multiple auxiliary systems. The presence of this at least one switch-off condition is thus checked outside auxiliary systems 1, 5, 10, 15, 20. As described, the check is performed in means 35, 40, 45, 50 centrally for all auxiliary systems 1, 5, 10, 15, 20. In addition, the presence of the at least one switch-off condition is checked in control center 25 on the basis of switch-off signals A1, A2, A3, A4. Alternatively it may be provided that the check on the presence of the at least one switch-off condition takes place in precisely one of auxiliary systems 1, 5, 10,15, 20 or in a module assigned to that auxiliary system, whereby the function of control center 25 or means 35, 40, 45, 50 is shifted to this auxiliary system or the assigned module. Control center 25 is not needed in this case.

If the at least one switch-off condition is present, one or multiple switch off or performance reduction signals are transmitted centrally, i.e., from control center 25 or from the analyzing auxiliary system or auxiliary system module, to those auxiliary systems 1, 5, 10, 15, 20 whose performance should be reduced or switched off when the at least one switch-off condition is present. According to the example in FIG. 1, those are all represented auxiliary systems. Depending on the switch-off condition met, this may also be fewer auxiliary systems. Additional auxiliary systems, not shown in FIG. 1, may also be provided for the switch off or performance reduction. When the at least one switch-off condition is present, auxiliary systems 1, 5, 10, 15, 20, provided for the switch off or performance reduction, are switched off or reduced in their performance in a coordinated manner by control center 25 or the analyzing auxiliary system.

As described, this coordination may mean that auxiliary systems 1, 5, 10, 15, 20 to be switched off or reduced in their performance are switched off or reduced in their performance in a predefined sequence. The predefined sequence may be suitably selected as a function of the respectively present switch-off condition or switch-off conditions.

As described, it may additionally be provided that a switch-off condition which is specific only for this auxiliary system, but not for the other auxiliary systems, is checked in at least one of auxiliary systems 1, 5, 10, 15, 20 or in a module assigned to this auxiliary system. As a result, switch-off conditions are also taken into account which do not depend on the operating state of the motor vehicle and are not relevant for multiple auxiliary systems, but rather relate specifically to only a single auxiliary system and its operating state.

Device 30 according to FIG. 1 includes means 35, 40, 45, 50 as well as control center 25 and auxiliary systems 1, 5, 10, 15, 20. As a central device, it may alternatively only include means 35, 40, 45, 50 and control center 25.

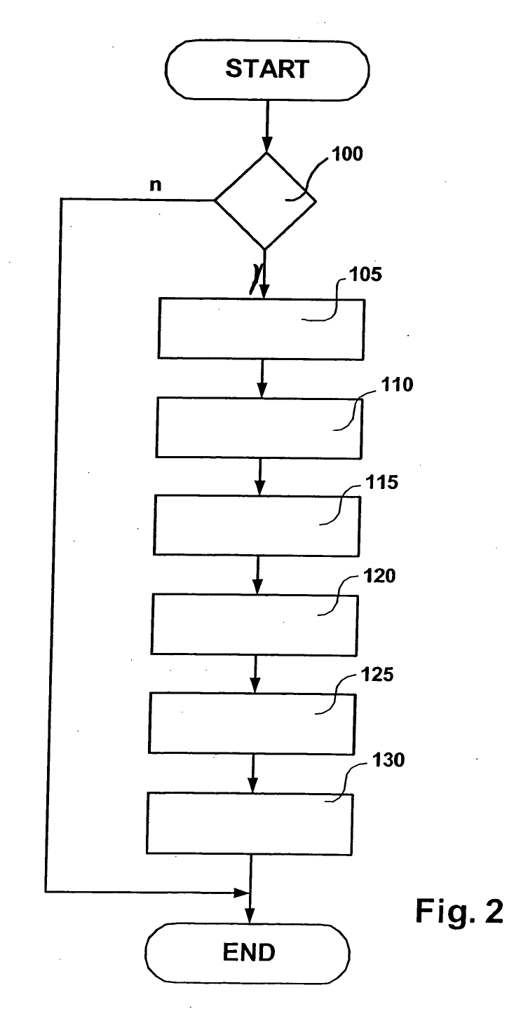

A specific example of a sequence of the method according to the present invention is subsequently given based on the sequence diagram in FIG. 2. After the program startup, control center 25 checks at a program point 100 whether a switch-off condition is met, e.g., whether fourth switch-off signal A4 is received, i.e., the vehicle system voltage is less than the predefined threshold value. If this is the case, the program branches to a program point 105, otherwise the program is exited or the presence of another switch-off condition is checked.

At program point 105, control center 25 determines a switch off or performance reduction strategy of auxiliary systems 1, 5, 10, 15, 20, which is predefined for the event that a vehicle system voltage is below the predefined threshold value and which may be stored in control center 25 or in a memory assigned to control center 25. This switch off or performance reduction strategy is subsequently implemented. This means in the present case, for example, that at a program point 110 a switch-off signal AN1 is initially transmitted to generator 1, whereby generator 1 is switched off. At a program point 115, a performance reduction signal AN2 is subsequently transmitted to heater 5 via which the performance of heater 5 is reduced to a first predefined value. At a program point 120, a switch-off signal AN3 is subsequently transmitted to air-conditioner compressor 10, whereby air-conditioner compressor 10 is switched off. At a program point 125, a performance reduction signal AN4 is subsequently transmitted to fan 15 via which the performance of fan 15 is reduced to a second predefined value. At a program point 130, a switch-off signal AN5 is subsequently transmitted to power-steering pump 20, whereby power-steering pump 20 is switched off.

The program is subsequently exited. The sequence diagram in FIG. 2 thus shows an example in which, in the event of a vehicle system voltage below the predefined threshold value, the coordination of the switch off or performance reduction of individual auxiliary systems 1, 5, 10, 15, 20 provides a predefined sequence for the switch off or performance reduction of individual auxiliary systems 1, 5, 10, 15, 20, different measures, which differ in degree from performance reduction up to the switch off, being provided for different auxiliary systems.

The predefined switch off or performance reduction strategy of auxiliary systems 1, 5, 10, 15, 20 thus makes it possible to individually configure the response of each auxiliary system in the presence of the corresponding switch-off condition, in the above-described example on the basis of the extent of the performance reduction for the particular auxiliary system, and to simultaneously adjust the response of the rest of the affected auxiliary systems in a suitable manner, in the above-described example by establishing a certain sequence of the switch off or performance reduction of the individual auxiliary systems.

In the exemplary embodiment according to FIG. 2, falling below the predefined threshold value is described as the switch-off condition. Of course, any other switch-off condition, dependent on the motor vehicle's operating state, may alternatively result in a corresponding manner in the switch off or performance reduction of one or multiple auxiliary system(s) of the motor vehicle, possibly in a sequence predefined for the present switch-off condition or simultaneously. Therefore, it may be provided in the event of a full-load operating state that all auxiliary systems are switched off simultaneously, in order to make the maximum possible torque for propulsion available to the engine. In the event of the presence of this or another switch-off condition, it is also possible, for example, that two auxiliary systems are switched off or reduced in their performance simultaneously and subsequently the rest of the auxiliary systems. Moreover, not all auxiliary systems have to necessarily be switched off or reduced in their performance in the presence of a switch-off condition. In other words, any sequence and any degree of performance reduction is possible for the individual auxiliary systems, depending on the present switch-off condition. Moreover, depending on the present switch-off condition, it is possible to predefine any time period during which the individual auxiliary systems remain switched off or reduced in their performance.

Furthermore, the described switch-off coordination of the auxiliary systems may be refined in such a way that different switch-off sequences, switch-off periods and/or performance reduction degrees are predefined for a repeated switch off of the auxiliary systems in order to prevent, for example, that one auxiliary system is permanently switched on and off in the repeated presence of the corresponding switch-off condition.

In the case of air-conditioner compressor 10, the air-conditioner compressor pressure should be noted as an example of an auxiliary system-specific switch-off condition. If the air-conditioner compressor pressure exceeds a predefined threshold value, air-conditioner compressor 10 is switched off because of a burst hazard. This switch-off condition is checked in air-conditioner compressor 10 itself or in a module assigned to air-conditioner compressor 10, with the aid of a pressure sensor, for example. The mentioned switch-off condition is only relevant for air-conditioner compressor 10 and not for the rest of the auxiliary systems.

On omission of the centrally or specifically checked switch-off conditions, the affected auxiliary systems may be appropriately switched on again, i.e., also in any predefined sequence and in any predefined performance degree.

1. A method for operating a motor vehicle including auxiliary systems, the method comprising:
predefining at least one switch-off condition for a plurality of auxiliary systems as a function of an operating state of the motor vehicle; and
checking centrally a presence of the at least one switch-off condition for the auxiliary systems.

2. The method according to claim 1, wherein the presence of the at least one switch-off condition is checked in a control center outside the auxiliary systems.

3. The method according to claim 1, wherein the presence of the at least one switch-off condition is checked in one of (a) precisely one of the auxiliary systems and (b) an auxiliary system module assigned to one of the auxiliary systems.

4. The method according to claim 1, further comprising, in the presence of the at least one switch-off condition, centrally transmitting one of a switch-off signal and a signal for performance reduction to the auxiliary systems to be one of (a) switched off and (b) reduced in their performance.

5. The method according to claim 1, further comprising, in the presence of the at least one switch-off condition, one of (a) switching off and (b) reducing in their performance the auxiliary systems to be one of (a) switched off and (b) reduced in their performance, in a coordinated manner.

6. The method according to claim 5, wherein the auxiliary systems are one of (a) switched off and (b) reduced in their performance in a predefined sequence.

7. The method according to claim 1, wherein in one of (a) at least one of the auxiliary systems and (b) an auxiliary system module assigned to one of the auxiliary systems, a switch-off condition is checked which is specific for the auxiliary system.

8. The method according to claim 1, wherein the at least one switch-off condition includes a presence of at least one of a full-load operating state, an acceleration operating state, a starting state, and a state of a vehicle system voltage below a predefined threshold value.

9. The method according to claim 1, wherein the auxiliary systems include at least one of a generator, a heater, an air-conditioner compressor, a fan, and a power-steering pump.

10. A device for operating a motor vehicle including auxiliary systems, at least one switch-off condition being predefined for a plurality of auxiliary systems as a function of an operating state of the motor vehicle, the device comprising:
means for centrally checking a presence of the at least one switch-off condition for the auxiliary systems.
